(19) United States
(12) Patent Application Publication
(10) Pub. No.: US 2004/0212743 A1
(43) Pub. Date: Oct. 28, 2004

(54) Image display apparatus and method of setting up the same

(75) Inventor: Yuko Yamazaki, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/804,121

(22) Filed: Mar. 19, 2004

(30) Foreign Application Priority Data
Apr. 28, 2003 (JP) 2003-124149

(51) Int. Cl. H04N 11/00

(52) U.S. Cl. 348/734; 348/552

(57) ABSTRACT

An image display apparatus connected to external unit, comprises receiving section receiving remote-control codes sent from remote-control terminal, memory storing conversion information causing identification information about remote-control code groups acceptable to external unit to correspond to external unit, converting section converting remote-control codes received by receiving section into remote-control codes acceptable to external unit on basis of conversion information, transmitting section transmitting remote-control codes, detecting section detecting change in state of external unit corresponding to specific operation by use of remote-control terminal, setting-up section which, when change in state of external unit has been sensed, determines identification information about remote-control code group including remote-control code making change in the state, creates conversion information to correspond to external unit, and stores conversion information into memory, and control section which, when conversion information isn't stored in memory, creates conversion information and stores the information into memory.

### CROSS-REFERENCE TO RELATED APPLICATIONS

This application is based upon and claims the benefit of priority from prior Japanese Patent Application No. 2003-124149, filed Apr. 28, 2003, the entire contents of which are incorporated herein by reference.

### BACKGROUND OF THE INVENTION

1. Field of the Invention

This invention relates to an image display apparatus for displaying images, such as television program images or video images, and a method of setting up the remote-control-related functions of the image display apparatus.

2. Description of the Related Art

Many of the image display apparatuses are used in combination with an external unit, such as a video unit or a TV tuner. To operate those apparatuses from a distant place, an infrared remote-control device is often used. By installing an external unit in such a manner that the user can see the infrared light-receiving section, the user can remote-control the external unit, while he or she is staying in the watching position.

If a rack on which the image display apparatus is put can be used or a shelf can be provided on the top of the image display apparatus, installing an external unit on the image display apparatus enables the user to see the light-receiving section from the watching position. In recent years, however, image display apparatuses have been getting larger and larger. Thus, when a projection television is combined with an external unit, it is becoming more difficult to secure a space to install an external unit in an unobstructed view position. In such a case, the infrared rays from the remote-control device sometimes do not reach the light-receiving section.

To overcome this problem, many of the recent image display apparatuses have a remote-control code transmitting function. An image display apparatus with this function has an infrared light-receiving section and transmitting section. The apparatus can amplify and waveform-reproduce the infrared light received at the light-receiving section and then transmit the resulting signal from the transmitting section. Providing the transmitting section by the side of the external unit via a wiring material enables the user to select the installation location of the external unit freely.

Some of the image display apparatuses have not only the function of relaying infrared rays but also the function of converting the received remote-control code into another code. The converting function enables the user to operate a plurality of external units with a singe remote-control terminal according to the guidance message displayed in symbols on the screen of the image display apparatus.

Techniques related to remote-control functions for an external unit have been disclosed in Jpn. Pat. Appln. KOKAI Publication No. 2002-354351 (hereinafter, referred to as reference 1) and Jpn. Pat. Appln. KOKAI Publication No. 11-75270 (hereinafter, referred to as reference 2).

Reference 1 has disclosed an apparatus which enables an external unit connected to the selected interface to be controlled automatically, interlocking with the switching of the input. With this apparatus, just switching the external input to the image display apparatus makes it possible to cause the desired external unit to perform a playback operation or to turn off the power supply of the external unit in operation before the switching.

Reference 2 has disclosed an AV system which prevents the opposite operation to the user's intention to be carried out, when a plurality of external units whose power supply is turned on and off alternately each time the remote-control code signal is received are controlled.

To use the remote-control code converting function of an image display apparatus, a preliminary setting-up work is needed. Specifically, it is necessary to cause the image display apparatus to recognize the setup code for the remote-control device corresponding to the name of the external unit, the manufacturer identification information, or the like and store the code. The setup code for the remote-control device is an identification code for specifying a remote-control code group the external unit can accept. The remote-control code group is composed of a plurality of remote-control codes corresponding to such operations as the on/off switching of the power supply, reproduction, stop, channel changing, and sound changing.

To set up the remote-control function of the external unit provided in the existing image display apparatus, the user has to acquire information on the maker of the external unit, the model name, and others and set the data corresponding to the information manually for each unit. This forces the user to do very troublesome operations. Therefore, there has been a need to overcome the disadvantage. In reference 1 and reference 2, however, no proposal to reduce time and labor needed to set up the remote-control function has been made.

### BRIEF SUMMARY OF THE INVENTION

According to an aspect of the present invention, there is provided an image display apparatus connected to an external unit, includes a receiving section which receives remote-control codes sent from a remote-control terminal; a memory which stores conversion information that causes identification information about remote-control code groups acceptable to the external unit to correspond to the external unit; a converting section which converts the remote-control codes received by the receiving section into remote-control codes acceptable to the external unit on the basis of the conversion information; a transmitting section which transmits the remote-control codes created by the converting section to the external unit; a detecting section which detects a change in the state of the external unit corresponding to a specific operation by use of the remote-control terminal; a setting-up section which, when a change in the state of the external unit has been sensed, determines identification information about the remote-control code group including the remote-control code making the change in the state, creates the conversion information so as to correspond to the external unit, and stores the conversion information into the memory; and a control section which, when the conversion information is not stored in the memory, creates the conversion information and stores the information into the memory.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows a system including an image display apparatus according to an embodiment of the present invention;

FIG. 2 is a detailed functional block diagram of the system of FIG. 1;

FIG. 3 is a flowchart to help explain the procedure for processing in the setting-up section 14b of FIG. 2;

FIG. 4 shows a screen which prompts the user to start a setting-up process;

FIG. 5 is a screen which informs the user that the setting-up process is completed;

FIG. 6 shows an example of a representation on the screen when the remote-control-related function of the television receiver 10 is used; and

FIG. 7 schematically shows an example of the setup code table 16a.

### DETAILED DESCRIPTION OF THE INVENTION

Hereinafter, referring to the accompanying drawings, an embodiment of the present invention will be explained.

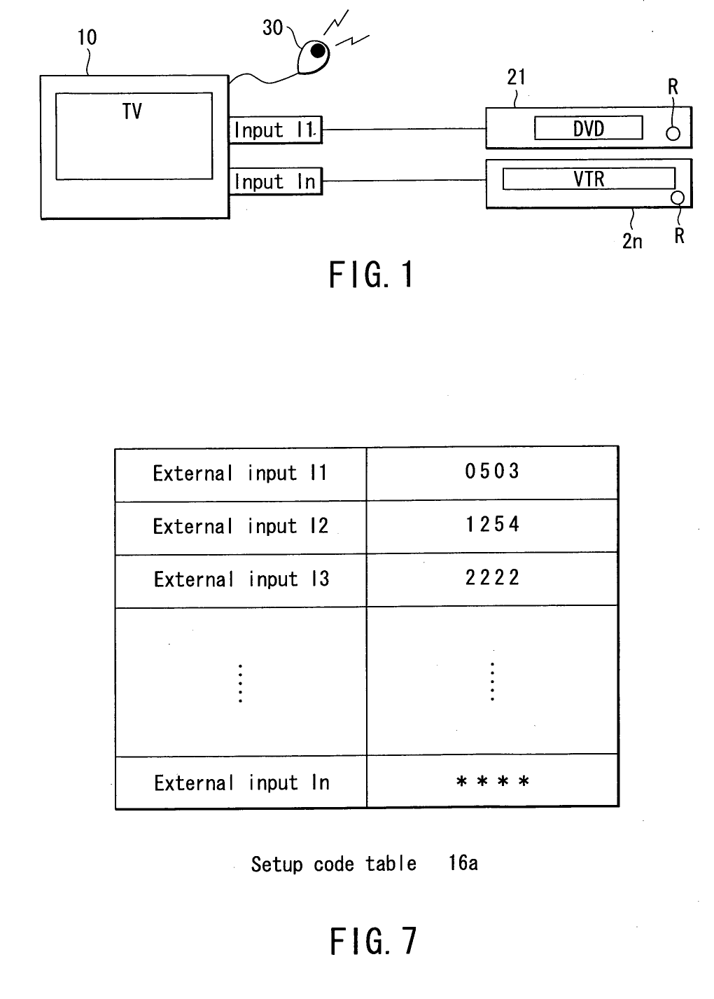

FIG. 1 schematically shows a system including an image display apparatus according to an embodiment of the present invention. The system comprises a television (TV) receiver 10 with a remote-control code output section 30 and a plurality of external units 21 to 2n provided on, for example, the back of the television receiver 10. The external units 21 to 2n, which are apparatuses that output video signals, such as DVD (Digital Versatile Disk) players and VTRs (Video Tape Recorders), are connected to external input terminals (input 1 to input n) of the television receiver 10, respectively. The external units 21 to 2n are provided in such a manner that their light-receiving sections R face the remote-control code output section 30.

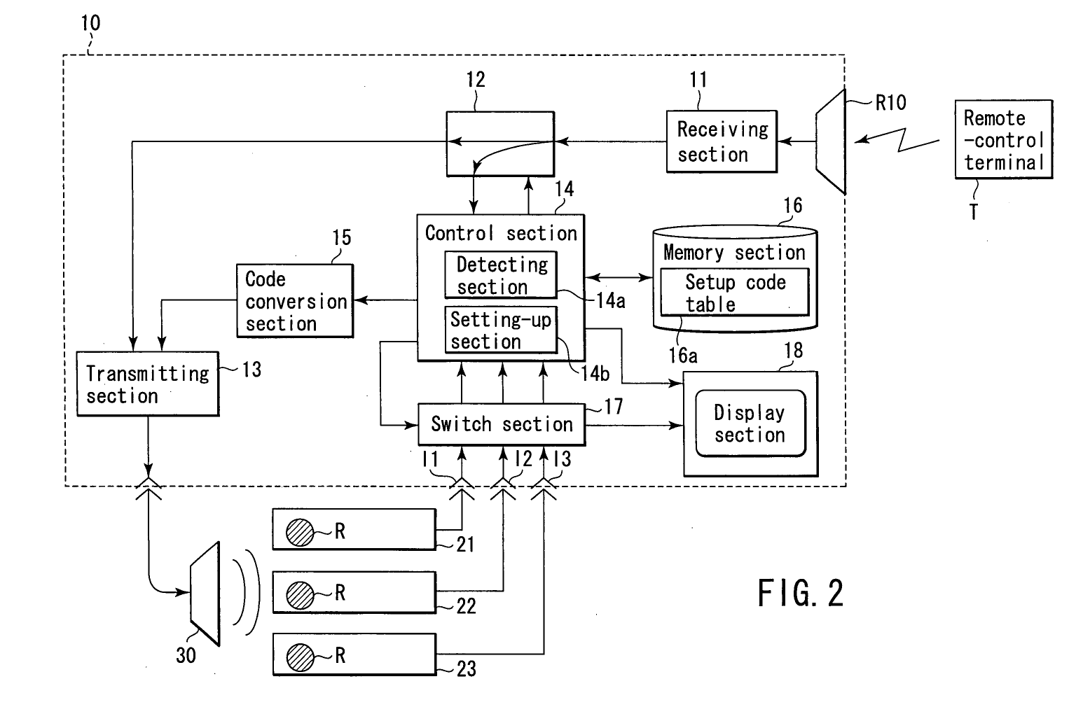

FIG. 2 is a detailed functional block diagram of the system of FIG. 1. In FIG. 2, an infrared remote-control code transmitted from a remote-control terminal T is converted photoelectrically at a light-receiving section R10 of the television receiver 10. The resulting signal is inputted to a switching section 12 via a receiving section 11. The switching section 12 switches between a transmitting section 13 and a control section 14 and inputs the photoelectrically converted remote-control code to one of them.

When the remote-control is inputted to the transmitting section 13 via the switching section 12, it passes through the television receiver 10 as it is and is outputted from the remote-control code output section 30. This operation mode is called the “pass-through mode.” On the other hand, when the remote-control code is supplied to the control section 14, the control section 14 inputs the remote-control code to a code conversion section 15. Referring to a setup code table 16a stored in a memory section 16, the code conversion section 15 converts the code pattern of the inputted remote-control code into a different pattern. This operation mode is called the “conversion mode.”

To the television receiver 10, for example, the external units 21 to 23 of three systems are connected via external input terminals I1 to I3. The video signals inputted from the external input terminals I1 to I3 are supplied to a display section 18 via a switch section 17 to a display section 18, which displays the signal as an image. The display section 18 displays an image together with a guidance message supplied from the control section 14. During the work of setting up the remote-control function, each video signal is also supplied to the control section 14.

The control section 14 includes a detecting section 14a and a setting-up section 14b. The detecting section 14a monitors the video signals outputted from the external units 21 to 23 and detects changes in the states of the external units 21 to 23 separately. The setting-up section 14b creates a setup code table 16a and stores the table into the memory section 16. The setup code table 16a is a table which shows the correspondence between the remote-control codes and the external units and which is used to convert a remote-control code in the “conversion mode.”

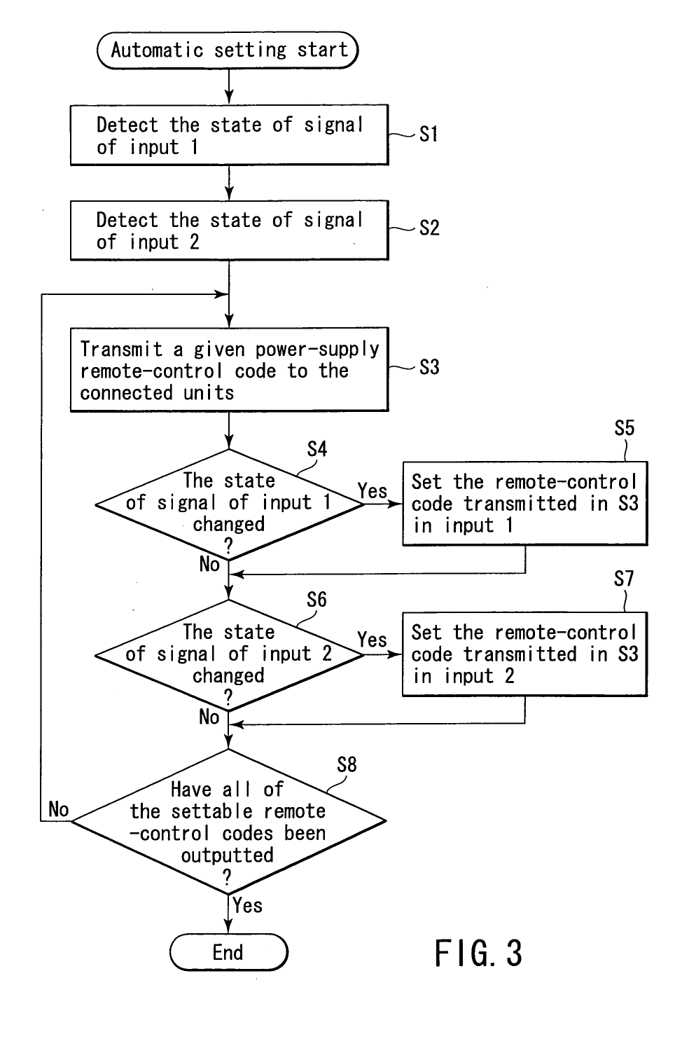

FIG. 3 is a flowchart to help explain the procedure for processing in the setting-up section 14b of FIG. 2. In the flowchart, suppose the external units 21, 22 are connected to the external input terminals I1, I2 (input 1, input 2), respectively. When the procedure for setting up the functions of the remote-control device is started by the user's instruction, the setting-up section 14b detects the states of the video signals of input 1 and input 2 (step S1, step S2). In these steps, the setting-up section 14b monitors the states of the video signals and realizes the on/off state of each of the external units 21, 22.

Next, the setting-up section 14b transmits a given power-supply remote-control code to the external units 21, 22 connected (step S3). Specifically, in this step, of the codes included in a plurality of remote-control code sets (or remote-control code groups) distinguished by individual setup codes, the ones for turning on and off the power supply are sent sequentially.

Next, the setting-up section 14b monitors the signal states of input 1 and input 2, thereby determining whether there has been a change in the states of the external units 21, 22 (step S4, step S6). If there has been no change in either step (No), that is, there has been no change in the state of either external unit according to the sent remote-control code, the processing procedure goes to step S8.

On the other hand, if there has been a change in step S4 (Yes), that is, if it has been sensed that the state of the external unit 21 has changed according to the sent remote-control code, this means that the functions of the external unit 21 can be operated by using the remote-control code group including the remote-control code. That is, the remote-control code group for operating the external unit 21 is determined. With this determination, the setting-up section 14b sets the remote-control code transmitted at this stage in input 1. That is, the setup code representing the determined remote-control code group is caused to correspond to the external unit 21 and this correspondence is set in the setup table 16a (step S5).

Similarly, if there has been a change in step S6 (Yes), this means that the functions of the external unit 22 can be operated by using the remote-control code group including the remote-control code. That is, the remote-control code group for controlling the external unit 22 is determined. Thus, the setting-up section 14 causes the setup code representing the determined remote-control code group to correspond to the external unit 22 and sets this correspondence in the setup table 16a (step S7).

The procedures of step S3 to step S7 is repeated until the states of both of the external units 21, 22 have changed. That is, when there has been a change in the state of each of the external units 21, 22, the procedure of FIG. 3 is completed. However, when the state of one of the external units 21, 22 has not changed even if all of the on/off control codes have been sent, the setting-up procedure is not completed. In this case, the user is informed of this and prompted to carry out a setting-up process manually by performing specific operations.

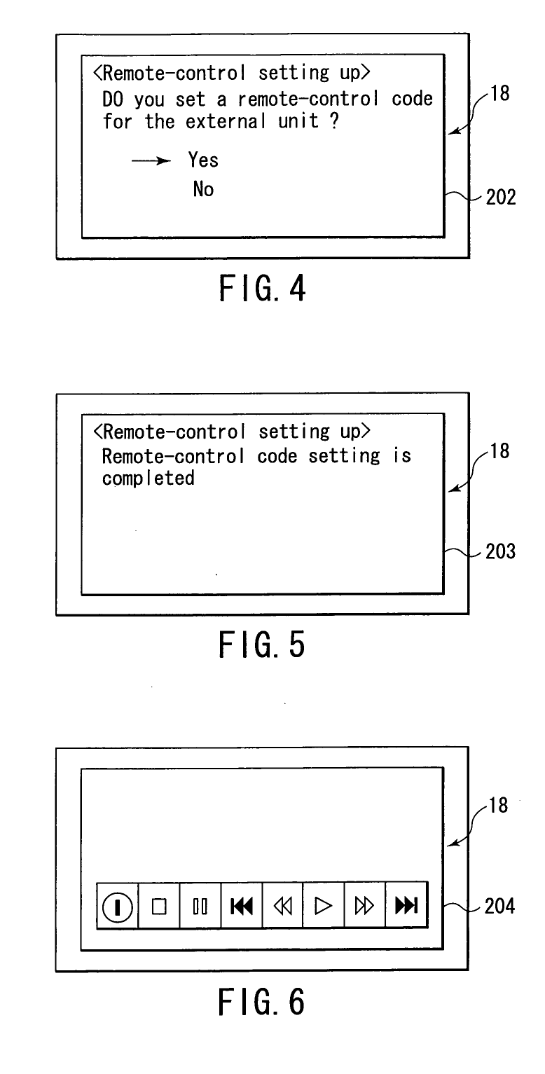

FIGS. 4 to 6 show examples of guidance representations on the display section 18 of FIG. 2. FIG. 4 shows a screen which prompts the user to start a setting-up process. On the screen 202, a message to ask whether to carry out the setting-up process is displayed. On the screen, if Yes is selected, the processing procedure of FIG. 3 is conducted.

FIG. 5 is a screen which informs the user that the setting-up process is completed. The screen 203 informs the user that the setting-up process of the remote-control code is completed.

FIG. 6 shows an example of a representation on the screen when the remote-control-related function of the television receiver 10 is used. On the screen 204, symbols for controlling functions, including reproduction, stop, and fast-forward, are displayed. Selecting and specifying an arbitrary symbol on the screen enables both of the external units 21, 22 to be operated in the same manner. This is because the remote-control code is converted inside the television receiver 10. Specifically, the television receiver 10 converts the code sent from the remote-control terminal T into a code for operating the desired external unit on the basis of the setup code table 16a.

FIG. 7 schematically shows an example of the setup code table 16a. As shown in FIG. 7, the setup code table 16a is a table which causes the remote-control setup codes to correspond to the external inputs I1 to In in a one-to-one correspondence.

In the embodiment, the remote-control codes for turning on and off the power supplies of the external units 21, 22 are sent one after another to the external units 21, 22 on a setup code basis. Changes in the states of the external units 21, 22 according to the sent codes are detected by monitoring changes in the video signals. When it has been sensed that the power supply has changed from on to off or from off to on, this means that the external unit can be controlled by using the remote-control code group including the remote-control code at that time. Making use of this, the correspondence between the external units and the setup codes is detected automatically, thereby automating the remote-control-related function setting-up process.

Accordingly, with the embodiment, the television receiver need not acquire information on the external units in the setting-up process. Since the setting-up process is carried out automatically, this makes the products more easy-to-use.

The present invention is not limited to the above embodiment. For instance, while in the embodiment, the television receiver has been provided with the remote-control code converting function, this function may be provided for the remote-control terminal T. Specifically, if the setup code table 16a is stored into the remote-control terminal T and the remote-control terminal T recognizes the external unit to be controlled, the remote-control terminal T can create a code for controlling a different external unit. In this case, the television receiver 10 is set in the “pass-through mode.”

Generally, a specific standby time is often required from when a remote-control code is sent until the state of the external unit has changed. In such a case, it takes a long time to complete the setting-up process by the approach of sending all of the remote-control codes one by one sequentially and waiting for a response from the external unit. To avoid this shortcoming, the following approach is used.

All of the remote-control codes are divided into a plurality of groups. After the remote-control codes are sent consecutively or in a broadcasting manner on a group basis, the elapse of the standby time is waited for. For instance, if the number of setup codes is 100, the number of on/off codes will be also 100. The 100 on/off codes are divided into, for example, two groups of 50. First, the codes belonging to one group are transmitted in a broadcasting manner. Then, the elapse of the standby time is waited for. If the state of the external unit has changed, any code belonging to the group fits the external unit. Then, the 50 codes are further divided into two groups of 25 and a similar process is repeated. In this way, determining the desired setup code asymptotically enables the time required for the setting-up process to be shortened remarkably.

To summarize what has been explained above, with the present invention, of the remote-control codes included in each remote-control code group, for example, the ones for turning on and off the power supply are sent to the external unit. The external unit responds to only one of the remote-control codes and switches the power supply from off to on or from on to off. When the switching is detected by the detecting section, this enables the image display apparatus to recognize the remote-control code group capable of controlling the external unit. That is, the image display apparatus can know the setup code corresponding to the external unit. This information is stored into the image display apparatus, which completes the remote-control-related function setting-up process. Moreover, a series of procedures are carried out automatically. Therefore, the user need not check for information about the external units and can complete the setting-up process without troublesome labor.

As described in detail above, it is possible to provide an image display apparatus which can reduce the trouble of setting up the remote-control-related functions and a method of setting up the image display apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display apparatus connected to an external unit, comprising:
a receiving section which receives remote-control codes sent from a remote-control terminal;
a memory which stores conversion information that causes identification information about remote-control code groups acceptable to the external unit to correspond to the external unit;
a converting section which converts the remote-control codes received by the receiving section into remote-control codes acceptable to the external unit on the basis of the conversion information;
a transmitting section which transmits the remote-control codes created by the converting section to the external unit;
a detecting section which detects a change in the state of the external unit corresponding to a specific operation by use of the remote-control terminal;
a setting-up section which, when a change in the state of the external unit has been sensed, determines identification information about the remote-control code group including the remote-control code making the change in the state, creates the conversion information so as to correspond to the external unit, and stores the conversion information into the memory; and
a control section which, when the conversion information is not stored in the memory, creates the conversion information and stores the information into the memory.

2. The image display apparatus according to claim 1, wherein
the specific operation is the operation of turning on and off the power supply of the external unit, and
the detecting section monitors a video signal outputted from the external unit and detects a change in the on and off state of the external unit.

3. The image display apparatus according to claim 1, wherein
when the detecting section has not detected a change in the state of the external unit after the remote-control codes corresponding to the specific operation in all of the remote-control code groups have been transmitted,
the setting-up section informs the user that the detecting section has not detected a change in the state of the external unit.

4. The image display apparatus according to claim 1, wherein
when a specific standby time is required from when the remote-control code is sent until the state of the external unit has changed,
the setting-up section divides the remote-control codes into a plurality of groups, transmits the remote-control codes consecutively on a group basis, waits for the elapse of the standby time, repeats the transmitting and waiting steps, and determines identification information about the remote-control code groups asymptotically.

5. A method of setting up an image display apparatus connected to an external unit, comprising:
a first step of receiving remote-control codes sent from a remote-control terminal;
a second step of storing conversion information that causes identification information about remote-control code groups acceptable to the external unit to correspond to the external unit;
a third step of converting the remote-control codes received into remote-control codes acceptable to the external unit on the basis of the conversion information;
a fourth step of transmitting the remote-control code created in the third step to the external unit;
a fifth step of detecting a change in the state of the external unit corresponding to a specific operation by use of the remote-control terminal;
a sixth step of, when a change in the state of the external unit has been sensed in the fifth step, determining identification information about the remote-control code group including the remote-control code making the change in the state, creating the conversion information so as to correspond to the external unit, and storing the conversion information into the memory; and
a seventh step of, when the conversion information is not stored in the memory, creating the conversion information and storing the information into the memory.

6. The method according to claim 5, wherein
the specific operation is the operation of turning on and off the power supply of the external unit, and
the fifth step is a step of monitoring a video signal outputted from the external unit and detecting a change in the on and off state of the external unit.

7. The method according to claim 5, further comprising:
an eighth step of, when a change in the state of the external unit has not been detected in the detecting step after the remote-control codes corresponding to the specific operation in all of the remote-control code groups have been transmitted, informing the user that a change in the state of the external unit has not been detected.

8. The method according to claim 5, wherein
when a specific standby time is required from when the remote-control code is sent until the state of the external unit has changed,
the fourth step is a step of dividing the remote-control codes into a plurality of groups and transmitting the remote-control codes consecutively on a group basis,
the fifth step is a step of detecting a change in the state of the external unit after the standby time has elapsed since the consecutive transmission of the remote-control codes, and
the sixth step is a step of repeating the transmitting step and the detecting step and determining identification information about the remote-control code groups asymptotically.
